(19) United States
(12) Patent Application Publication
(10) Pub. No.: US 2007/0198942 A1
(43) Pub. Date: Aug. 23, 2007

(54) Method and system for providing an adaptive magnifying cursor

(76) Inventor: Robert P. Morris, Raleigh, NC (US)

Correspondence Address: SCENERA RESEARCH, LLC, 111 Corning Road, Suite 220, Cary, NC, 27518, US

(21) Appl. No.: 10/955,191

(22) Filed: Sep. 29, 2004

(51) Int. Cl. G06F 3/048

(52) U.S. Cl. 715/767; 715/856

(57) ABSTRACT

A method and system for displaying an object having a shape on a graphical user interface having a cursor is described. The method and system include tracking a movement of the cursor and magnifying the object in response to the cursor being placed on a magnification zone. The magnification is performed such that a magnification area conforms to the shape of the object.

### FIELD OF THE INVENTION

The present invention relates to graphical user interfaces, and more particularly to a method and system for providing an adaptive cursor.

### BACKGROUND OF THE INVENTION

Graphical user interfaces (GUIs) are ubiquitous in computing devices, including desktop devices, and portable computing devices such as laptops, digital imaging devices such as digital cameras, personal digital assistants, cellular phones and camera phones. Such GUIs allow users to interact with the computing device through the display. For example, users may view information, such as thumbnail images, text, icons, or other information that is typically provided via menus. In addition, users may also input information, for example by selecting objects such as sections of text, images, or utilizing menus through the GUI. In order to input or retrieve information through a GUI, a user typically uses a pointer or cursor. For example, a user may select particular menu or other items by moving the cursor on the corresponding icon and clicking. Note that the terms pointer and cursor are used interchangeably herein.

Although GUIs function, one of ordinary skill in the art will readily recognize that there are drawbacks. In particular, the present trend in portable computing devices is to smaller device sizes. Consequently, the display on such portable computing devices may be smaller. As a result, items depicted on the displays are smaller. The information in such items may thus be more difficult to discern. For example, thumbnail images, which are smaller typically lower resolution images which can be displayed together on the display of a computing device, may be difficult to view. In addition, navigating through menus or selecting items may be more difficult. For example, it may be difficult for a user to determine on which item the cursor resides. Thus, a user may inadvertently select an item other than that which is desired. This situation exists on large displays as well. For example, a user of a PC may desire to minimize a window. However, because the minimize and close buttons are both typically located near the upper right corner of the window, a user may inadvertently close the window instead of minimizing the window.

Conventional computing devices address this issue by providing limited magnification and snapping abilities. For example, some conventional computing devices provide a fixed shape and size, such as a circle or rectangle having a specified size, corresponding to the cursor. Objects or portions of objects within the fixed shape are magnified. Other conventional systems allow a user to set the size and aspect ratio of the area magnified, but still require a fixed shape. For example, a user might be allowed to define a rectangular frame within which objects are magnified. In snapping, for example in drawings programs including a grid, the cursor snaps to a particular position within an object under certain conditions. For example, the cursor may snap to the center of the object if the cursor is moved onto the object when the cursor is being used to modify the shape or size of the object. Similarly, in WINDOWS, the cursor snaps to a default button on new dialog windows or panels.

Although the abilities of conventional computing devices to magnify or snap to objects may improve the ability of a user to utilize a GUI, one of ordinary skill in the art will readily recognize that there are still drawbacks. Some conventional systems distort portions of the area being magnified. Consequently, it may be difficult for a user to view certain objects, such as images, with sufficient clarity. Furthermore, objects having varying size and/or shape may be difficult to adequately view using fixed size or shape magnification. Similarly, neighboring objects which are not desired to be magnified may be not be magnified, or vice versa. In addition, it may still be difficult to use the cursor to navigate over an object on a small display or a small object on a large display.

Accordingly, what is needed is a mechanism for improving a user's ability to employ a GUI. The present invention addresses such a need.

### BRIEF SUMMARY OF THE INVENTION

The present invention provides a method and system for displaying an object having a shape on a graphical user interface having a cursor. The method and system comprise tracking a movement of the cursor and magnifying the object in response to the cursor being placed on a magnification zone. The magnification is performed such that a magnification area conforms to the shape of the object.

According to the method and system disclosed herein, the present invention provides magnification and/or snapping features that adapt to the objects of interest and may be used in a variety of circumstances.

### BRIEF DESCRIPTION OF SEVERAL VIEWS OF THE DRAWINGS

FIG. 1 is a high-level flow chart depicting one embodiment of a method in accordance with the present invention for providing adaptive magnification.

FIG. 2 is a high-level flow chart depicting another embodiment of a method in accordance with the present invention for providing adaptive magnification.

FIG. 3 is a diagram depicting one embodiment of a graphical user interface in accordance with the present invention in which one portion of the text is magnified.

FIG. 4 is a diagram depicting one embodiment of a graphical user interface in accordance with the present invention in which another portion of the text is magnified.

FIG. 5 is a diagram depicting one embodiment of a graphical user interface in accordance with the present invention in which one image is magnified.

FIG. 6 is a diagram depicting one embodiment of a graphical user interface in accordance with the present invention in which another image is magnified.

FIG. 7 is a more detailed flow chart depicting one embodiment of a method in accordance with the present invention for providing adaptive magnification.

FIG. 8 is a more detailed flow chart depicting one embodiment of a method in accordance with the present invention for providing adaptive snapping.

FIG. 9 is a diagram depicting one embodiment of a system in accordance with the present invention for providing adaptive magnification and/or snapping.

### DETAILED DESCRIPTION OF THE INVENTION

The present invention relates to graphical user interfaces. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method and system for displaying an object having a shape on a graphical user interface having a cursor. The method and system comprise tracking a movement of the cursor and magnifying the object in response to the cursor being placed on a magnification zone. The magnification is performed such that a magnification area conforms to the shape of the object.

The present invention will be described in terms of a digital imaging device, such as a digital camera. However, one of ordinary skill in the art will readily recognize that the method and system operate for other devices having a graphical user interface. The method and system are also described in the context of specific objects being magnified or snapped to, such as images or text. However, one of ordinary skill in the art will readily recognize that the method and system can be used with other objects. The present invention is also described in the context of a cursor, or pointer. However, one of ordinary skill in the art will readily recognize that the method and system are fully applicable to other pointing and/or selection mechanisms, including touch screens. In such systems, the cursor may be synonymous with another selection mechanism. The method and system are also described in the context of magnifying objects. However, one of ordinary skill in the art will readily recognize that magnifying could include enlarging and shrinking an object. Finally, the method and system are described in the context of a single object. However, one of ordinary skill in the art will readily recognize that the method and system can be used with multiple objects.

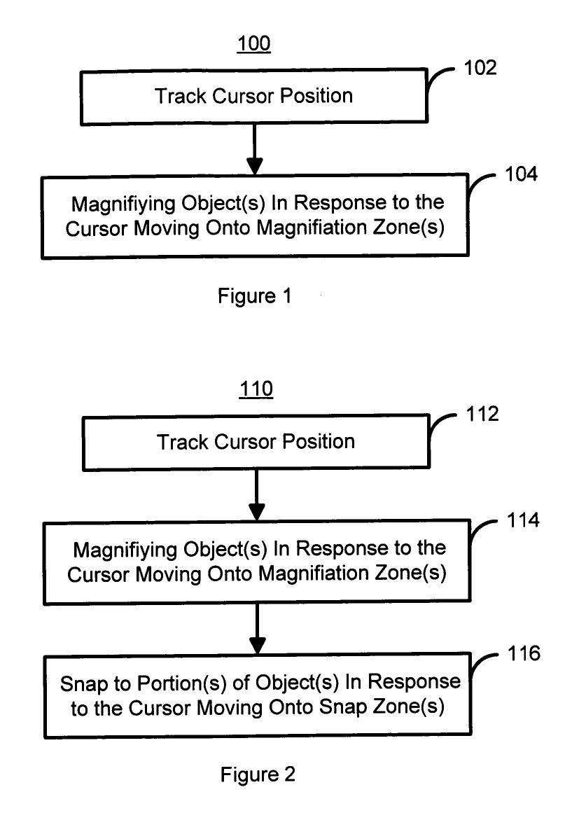

To more particularly illustrate the method and system in accordance with the present invention, refer to FIG. 1, depicting high-level flow chart of one embodiment of a method 100 in accordance with the present invention for providing adaptive magnification. The method 100 is preferably implemented on a computing device having a GUI that uses a cursor, or pointer. The position of the cursor within the display is tracked, via step 102. Thus, it can be determined where on the display the cursor resides. For example, because the position of the cursor is tracked, it can be determined on which object being displayed, if any, on which the cursor currently resides. Note that in one embodiment, the position of the cursor throughout the entire display is tracked in step 102. In another embodiment, step 102 merely determines whether the cursor moves onto one or more objects for which magnification is desired.

In response to the cursor being moved onto a magnification zone the object is magnified, via step 104. The object which is magnified in step 104 is preferably not restricted. Thus, the object may include, but is not limited to, an image, an icon, a menu item or other item depicted on the GUI. If the object is magnified, then in step 104 the magnification is performed such that a magnification area conforms to the shape of the object. The magnification zone is the region of the display on which the cursor is placed for object to be magnified. In a preferred embodiment, the magnification zone is identical to the object. In an alternate embodiment, the magnification zone might be larger or smaller than the object and/or may have a different shape from the object.

The amount of magnification used in step 104 may be linked to the content of the object being magnified. For example, for text objects, fine print may be magnified more than larger font text and large font may not be magnified at all. Similarly, when text is magnified, the text may be wrapped from one line to another. In addition, step 104 can include magnifying objects that are defined to be associated with the object on which the cursor resides. Further, as discussed above, the shape of the object, as magnified, conforms to the original shape of the object. For example, if the object is a circle, then at least a circle is magnified. If associated objects are also magnified, then their shapes preferably remain the same.

Using the method 100, a user may be better able to use the GUI. For example, magnification of the object conforms to the shape of the object and is customized to the object's characteristics and/or the user's needs. Thus, portions of the display which are not desired to be magnified need not be magnified. In addition, the area of interest, the object, is magnified rather than a region of some preset size and/or shape.

FIG. 2 depicts high-level flow chart of another embodiment of a method 1 10 in accordance with the present invention for providing adaptive magnification in conjunction with. The method 100 is preferably implemented on a computing device having a GUI that uses a cursor, or pointer. The position of the cursor within the display is tracked, via step 112. Step 112 is, therefore, analogous to step 102 of the method 100 depicted in FIG. 1. Referring back to FIG. 2, in one embodiment, the position of the cursor throughout the entire display is tracked in step 112. In another embodiment, step 112 merely determines whether the cursor moves onto one or more objects for which magnification and/or snapping, described below, are desired.

The object is magnified in response to the cursor being moved onto the magnification zone, via step 114. Step 114 is thus analogous to step 104 of FIG. 1. Referring back to FIG. 2, the magnification zone is the region on which the cursor is placed that results in the object being magnified. In a preferred embodiment, the magnification zone is the object. However, in another embodiment, the magnification zone can occupy a larger, smaller or differently shaped region of the display. The object which is magnified in step 114 is preferably not restricted. Thus, the object may include, but is not limited to, an image, an icon, a menu item or other item depicted on the GUI. If the object is magnified, then in step 114 the magnification is performed such that a magnification area conforms to the shape of the object. The amount of magnification provided in step 114 may be linked to the content of the object being magnified, as described above.

In response to the cursor being moved onto a snap zone the cursor is snapped to a portion of the object, via step 116. The snap zone is the region of the display on which the cursor is placed to be snapped. In one embodiment, the snap zone is the object. In another embodiment, the snap zone might be larger or smaller than the object and/or might have a different shape. Note that the snap zone and the magnification zone may be different in size and/or shape, but are generally the same. In addition, the object which is snapped to in step 116 is preferably not restricted. Thus, the object may include, but is not limited to, an image, an icon, a menu item or other item depicted on the GUI.

In performing the snap feature, the following operations may be performed. In one embodiment, step 116 includes snapping the cursor to the center of the object. In another embodiment, the cursor may be snapped to another portion of the object. In step 116, the cursor is preferably snapped to the center of the object when the cursor is first moved onto the snap zone. Also in a preferred embodiment, the cursor is allowed to move freely, without being snapped, if the cursor is moved away from the center or other selected portion of the snap zone (e.g. the object). In such an embodiment, it is preferred that the cursor is re-snapped to the center after the cursor has been moved out of and then reenters the snap zone. In addition, the system precludes overlapping of snap zones for different objects.

Using the method 110, a user may be better able to use the GUI. For example, magnification of the object conforms to the shape of the object and is customized to the object's characteristics and/or the user's needs. Thus, portions of the display which are not desired to be magnified need not be magnified. In addition, the area of interest, the object, is magnified rather than a region of some preset size and/or shape. The method 110 also allows simpler navigation due to the snap feature. For example, the snap feature may be used to automatically snap the cursor to the desired object or button. Consequently, the possibility that a user may inadvertently select the incorrect button may be reduced.

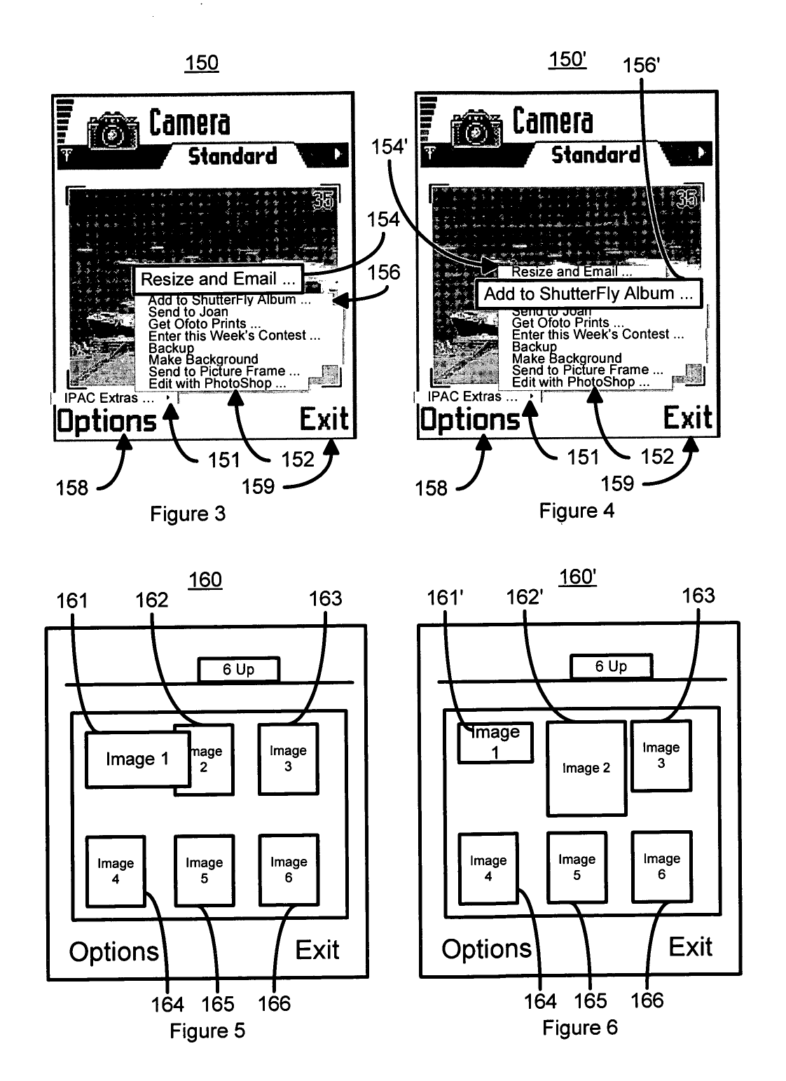

FIGS. 3-4 are diagrams depicting one embodiment of a GUI 150 and 150′, respectively, in accordance with the present invention in which one portion of the text is magnified using the method 100. The GUI 150 includes a region 152 in which text indicating menu options resides. This region outlines the IPAC extras indicated in item 151. Each line of text is a separate menu item and preferably a separate object. Thus, in the GUI 150 depicted in FIG. 3, the cursor resides on the object 154. Thus, the words “Resize and Email” are magnified. In the GUI 150′ depicted in FIG. 4, the cursor has been moved to object 156′. Consequently, the words “Add to ShutterFly Album” are magnified. In addition, the object 154′ has been restored to its original size. Note that in the GUIs 150 and 150′ if the cursor were placed on the objects 158 and 159 (options and exit, respectively), no magnification may result because the text is already large. Similarly, if the text selected were smaller, more magnification might be provided. However, in another embodiment, the objects 158 and/or 159 may be magnified.

FIGS. 5 and 6 are diagrams depicting one embodiment of another GUI 160 and 160′ in accordance with the present invention in which images are adaptively is magnified using the method 100 and/or 110. The GUI 160 displays six thumbnail images 161, 162, 163, 164, 165, and 166. In FIG. 5, the cursor resides on the thumbnail image 161. Consequently, the thumbnail image 161 is magnified. Note that the shape and orientation of the thumbnail image 161 is unchanged by the magnification. Similarly, in FIG. 6, the cursor resides on the thumbnail image 162′. Consequently, the thumbnail image 162′ is magnified without altering the shape or orientation of the image. In addition, the thumbnail 161′ has been restored to its original size. Moreover, in a preferred embodiment, the amount of magnification for the thumbnails 161 and 162′ may be selected by the user. Further, although not depicted, if another object, such as another thumbnail 163 or 164 or text describing the thumbnail (not shown), were associated with the thumbnail 161 and/or 162′, these objects may be magnified when the corresponding thumbnail 161 and/or 162′ is magnified.

Thus, the methods 100 and 110 allow for adaptive magnification of objects in the GUIs 150, 150′, 160, and 160′. Consequently, a user is better able to utilize the GUI. For example, magnification of the object conforms to the shape of the object 152, 154′, 161, and 162′, magnification is customized to the object's characteristics and/or the user's needs. Thus, portions of the display which are not desired to be magnified need not be magnified. In addition, the area of interest, the object, is magnified rather than a region of some preset size and/or shape.

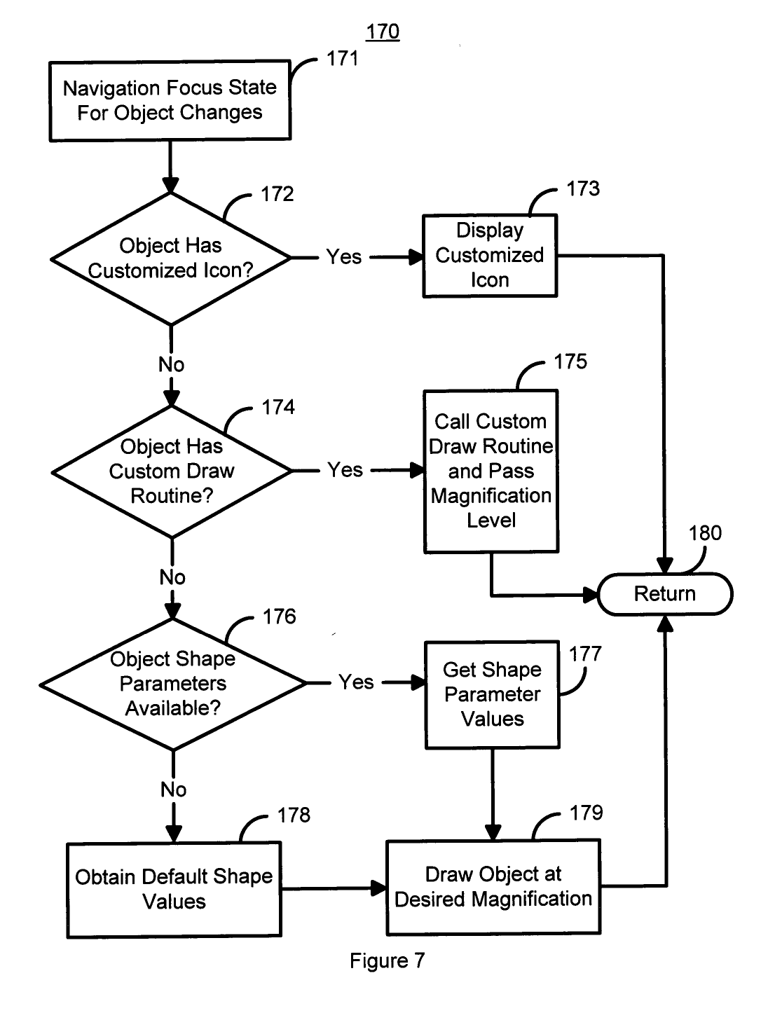

FIG. 7 is a more detailed flow chart depicting one embodiment of a method 170 in accordance with the present invention for providing adaptive magnification. The method 170 may be used in performing the magnification portion of step 104 of the method 100 depicted in FIG. 1. Referring back to FIG. 7, the navigation focus state for the object changes, via step 171. It is determined whether the object has one or more customized icons, via step 172. The customized icon(s) are magnified version(s) of the object. Step 172 thus determines whether customized icons for the magnified versions of the object are available. Step 172 may be preferred for objects such as menu items. If the customized icon(s) are available, then the customized icon is displayed, via step 173. For example, the graphics subsystem of a computing device may simply be able to display the customized icons in step 173, rather than requiring that the graphics subsystem perform any additional functions.

If customized icon(s) are not available, then it is determined whether the object is associated with a custom draw routine, via step 174. The customized draw routine would be capable of drawing the object at the desired magnification level and supported by the application (not shown) for which the objects are displayed. If the customized draw routine is available, then the customized draw routine is simply called, via step 175. In a preferred embodiment, the magnification at which the customized draw routine is to depict the object is input to the customized draw routine in step 175.

If the object does not have an associated customized draw routine, then it is determined whether the object's shape parameters are available, via step 176. If so, then the values for the object's shape parameters are obtained, via step 177. If not, then default shape values for shapes such as the object are obtained, via step 178. Using these values, then the object is drawn at the proper magnification, via step 179. In a preferred embodiment, steps 176 through 179 are performed by a graphics subsystem (not shown in FIG. 7) of the computing device on which the objects are displayed. Thus, through steps 173, 175, or 179, the object may be magnified. Thus, from steps 174, 175, and 179, the method returns, via step 180. Note that three mechanisms corresponding to the steps 173, 175, and 170 are depicted in the method 170 for magnifying the object, any combination might be implemented. For example, any combination of steps 172 and 173, steps 175 and 175, and/or steps 176-179 might be omitted. Furthermore, although only magnification of the object is described in the method 170, analogous steps may be performed for any associated object(s) to perform magnification of such associated objects.

Thus, using the method 170, a user may more easily view objects of interest. Magnification of the object conforms to the shape of the object and is customized to the object's characteristics and/or the user's needs. Thus, portions of the display which are not desired to be magnified need not be magnified. In addition, the area of interest, the object, is magnified rather than a region of some preset size and/or shape. Consequently, the method 170 facilitates the use of a GUI.

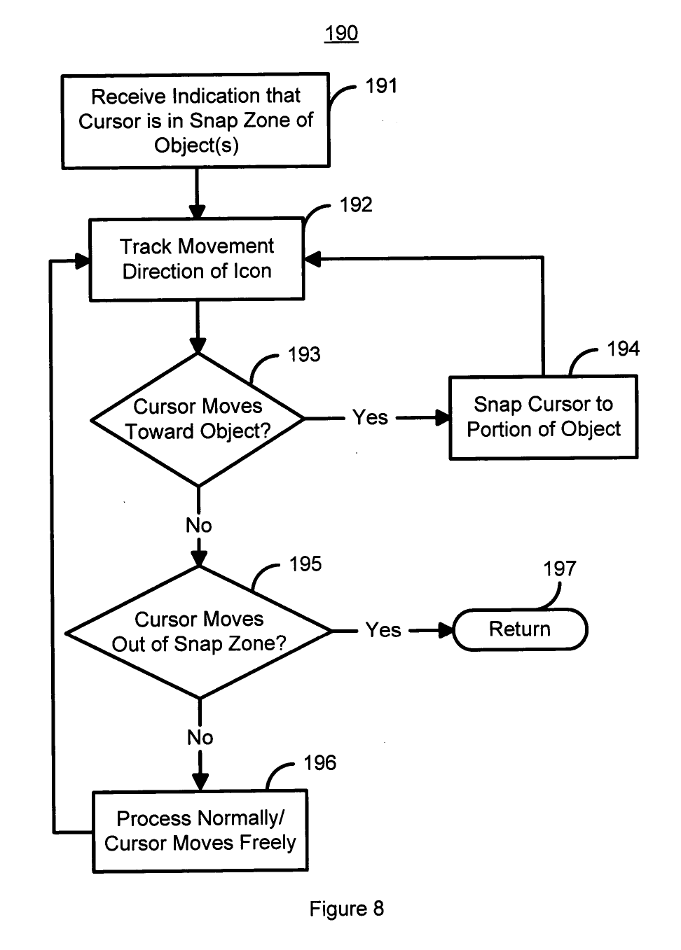

FIG. 8 is a more detailed flow chart depicting one embodiment of a method 190 in accordance with the present invention for providing adaptive snapping. The method 180 may be used in performing the snapping portion of step 116 of the method 110 depicted in FIG. 2. Referring back to FIG. 8, an indication that the cursor is in the snap zone for an object, via step 191. Thus, step 191 may include tracking the movement of the cursor through the display and providing an indication when the cursor moves into the snap zone. In another embodiment, the movement of the cursor is not tracked unless and until the cursor moves into the snap zone. The snap zone preferably corresponds to the object. However, the snap zone could be made larger or smaller than the object, and may also have a different shape from the object.

The direction of movement of the cursor is tracked, via step 192. In one embodiment, step 192 simply continues tracking of the cursor's movement. It is determined whether the cursor is moving towards the object, via step 193. In a preferred embodiment, step 193 includes determining whether the cursor is moved toward the center of the object or snap zone. If it is determined in step 193 that the cursor is moved toward the object, then the cursor is snapped to a particular portion of the object, via step 194. In a preferred embodiment, step 194 snaps the cursor to the center, or a central region, of the object. Also in a preferred embodiment, the portion of the object to which the cursor is snapped is selectable. Step 192 is then returned to so that the movement of the cursor is still tracked.

It is determined whether the cursor is moved outside of the snap zone, via step 195. If it is determined that the cursor has not moved out of the snap zone, then normal processing including normal movement of the cursor continues, via step 196. Thus, in a preferred embodiment, the cursor is allowed to move freely within the object as long as the cursor is not being moved toward the object. Step 192 is then returned to so that movement of the cursor continues to be tracked. If it is determined that the cursor has moved out of the snap zone, then the method returns in step 197. Thus, once the cursor moves out of the snap zone, the method 190 does not snap the cursor to the object and normal operation of the computing device continues.

Using the method 190, a user may be better able to navigate through the GUI. In particular, the method 190 also allows the cursor to automatically snap to the desired object or button. Consequently, the possibility that a user may inadvertently select the incorrect button may be reduced. Thus, the user's ability to navigate through and otherwise use the GUI is improved.

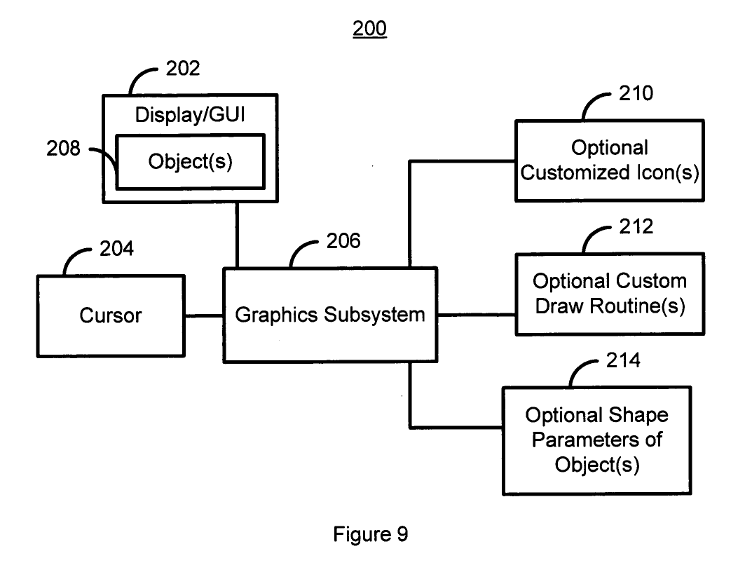

FIG. 9 is a diagram depicting one embodiment of a system 200 in accordance with the present invention for providing adaptive magnification and/or snapping. The system 200 includes a display 202 in which the GUI is displayed, a cursor 204 used in navigating the GUI, and a graphics subsystem 206. Also depicted are the object of interest 208, optional customized icon(s) 210, optional draw routine(s) 212, and optional shape parameter(s) for the object 214. In a preferred embodiment, the methods 100, 170, and 180 are performed by some combination of the graphics subsystem 202, the optional draw routine(s) 212, optional customized icon(s) 210, and optional shape parameter(s) for the object 214, as described in FIGS. 7 and 8. Consequently, one or more of the components 210, 212, and 214 might be used by the system 200 in order to perform the methods 100 and 170. Also in a preferred embodiment, the graphics subsystem 206 performs the method 190 and at least portion of the method 110 used in snapping the cursor.

Thus, using the system 200, the methods 100, 110, 170, and 190 may be performed. Consequently, the user's ability to view and navigate through portions of the GUI can be improved.

A method and system for performing adaptive magnification and, in some embodiments, snapping has been disclosed. The present invention has been described in accordance with the embodiments shown, and one of ordinary skill in the art will readily recognize that there could be variations to the embodiments, and any variations would be within the spirit and scope of the present invention. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Accordingly, many modifications may be made by one of ordinary skill in the art without departing from the spirit and scope of the appended claims.

1. A method for displaying an object having a shape on a graphical user interface having a cursor, comprising:
tracking a movement of the cursor;
determining the shape of the object; and
magnifying the object such that a magnification area conforms to the determined shape of the object in response to the cursor being placed on a magnification zone.

2. The method of claim 1 further comprising:
snapping the cursor to a portion of the object in response to the cursor moving onto a snap zone.

3. The method of claim 2 wherein the snapping further includes:
allowing the cursor to move freely when the cursor is moved away from the portion of the object and the cursor has not moved off of the snap zone.

4. The method of claim 2 further including:
allowing the user to set a size of the snap zone.

5. The method of claim 4 wherein the size of the snap zone is equal to the size of the object.

6. The method of claim 1 wherein the magnifying further includes:
displaying and magnifying a custom icon corresponding to the object if the custom icon exists in the system.

7. The method of claim 1 wherein the magnifying further includes:
utilizing a customized draw routine to magnify and display the object if the customized draw routine is supported by an application corresponding to the object.

8. The method of claim 1 wherein the magnifying further includes:
displaying the object using a graphics processing subsystem and at least one shape parameter associated with the object and relating to displaying the object, the graphics processor subsystem configured to determine the shape of the object and to magnify the object using the at least one shape parameter.

9. The method of claim 1 further including:
allowing the user to set a magnification.

10. The method of claim 1 wherein the object includes a content, the method further including:
allowing a magnification of the object to be determined based on the content of the object.

11. The method of claim 1 further including:
allowing at least a first object to be associated with the object such that when the object is magnified, the at least the first object is magnified.

12. The method of claim 1 further including:
allowing the user to alter a shape of the magnification zone to a shape different than the shape of the object.

13. The method of claim 1 wherein the magnification zone is the object.

14. A method for displaying an object having a shape on a graphical user interface having a cursor, comprising:
tracking a movement of the cursor;
determining the shape of the object;
magnifying the object such that a magnification area conforms to the determined shape of the object in response to the cursor being moved on the object, the magnifying further including
displaying and magnifying a custom icon corresponding to the object if the custom icon is available to the graphical user interface;
utilizing a customized draw routine to magnify and display the object if the customized draw routine is supported by an application corresponding to the object;
displaying the object using a graphics processing subsystem and at least one shape parameter associated with the object and relating to displaying the object, wherein the graphics processor subsystem is configured to determine the shape of the object and to magnify the object using the at least one shape parameter and is further configured to use
at least one default value for the shape of the object in magnifying the object if the custom icon is not available, the customized draw routine is not supported and the at least one shape parameter is unavailable; and
un-magnifying the object if the cursor is moved off of the object.

15. A computer-readable medium containing a program for displaying an object having a shape on a graphical user interface having a cursor, the program including instructions for:
tracking a movement of the cursor;
determining the shape of the object; and
magnifying the object such that a magnification area conforms to the determined shape of the object in response to the cursor being placed on a magnification zone.

16. The computer-readable medium of claim 15 wherein the program further includes instructions for:
snapping the cursor to a portion of the object in response to the cursor moving onto a snap zone.

17. The computer-readable medium of claim 16 wherein the snapping instructions further include instructions for:
allowing the cursor to move freely when the cursor is moved away from the particular portion of the object and the cursor has not moved off of the snap zone.

18. The computer-readable medium of claim 18 wherein the program further includes instructions for:
allowing the user to set a size of the snap zone.

19. The computer-readable medium of claim 18 wherein the size of the snap zone is equal to the size of the object.

20. The computer-readable medium of claim 15 wherein the magnifying instructions further include instructions for:
displaying and magnifying a custom icon corresponding to the object if the custom icon is available to the graphical user interface.

21. The computer-readable medium of claim 15 wherein the magnifying instructions further include instructions for:
utilizing a customized draw routine to magnify and display the object if the customized draw routine is supported by an application corresponding to the object.

22. The computer-readable medium of claim 15 wherein the magnifying instructions further include instructions for:
displaying the object using a graphics processing subsystem and at least one shape parameter associated with the object and relating to displaying the object, the graphics processor subsystem configured to determine the shape of the object and to magnify the object using the at least one shape parameter.

23. The computer-readable medium of claim 15 wherein the program further includes instructions for:
allowing the user to set a magnification.

24. The computer-readable medium of claim 15 wherein the object includes a content, and wherein the program further includes instructions for:
allowing a magnification of the object to be determined based on the content of the object.

25. The computer-readable medium of claim 15 wherein the program further includes instructions for:
allowing at least a first object to be associated with the object such that when the object is magnified, the at least the first object is magnified.

26. The computer-readable medium of claim 15 wherein the program further includes instructions for:
allowing the user to alter a shape of the magnification zone to a shape different than the shape of the object.

27. A computer-readable medium containing a program for displaying an object having a shape on a graphical user interface having a cursor, the program including instructions for:
tracking a movement of the cursor;
determining the shape of the object;
magnifying the object such that a magnification area conforms to the determined shape of the object in response to the cursor being moved on the object, the magnifying further including
displaying and magnifying a custom icon corresponding to the object if the custom icon is available to the graphical user interface;
utilizing a customized draw routine to magnify and display the object if the customized draw routine is supported by an application corresponding to the object;
displaying the object using a graphics processing subsystem and at least one shape parameter associated with the object and relating to displaying the object, wherein the graphics processor subsystem is configured to determine the shape of the object and to magnify the object using the at least one shape parameter and is further configured to use
at least one default value for the shape of the object in magnifying the object if the custom icon, the customized draw routine is not supported, and the at least one shape parameter is unavailable; and
un-magnifying the object if the cursor is moved off of the object.

28. A system for displaying an object having a shape on a graphical user interface having a cursor, comprising:
a graphics subsystem for tracking a movement of the cursor;
wherein the graphics subsystem is configured to determine the shape of the object and to magnify the object such that a magnification area conforms to determined the shape of the object in response to the cursor being placed on the object.

29. (canceled)

30. The system of claim 28 wherein the graphics subsystem further snaps the cursor to a portion of the object in response to the cursor moving onto a snap zone.

31. The system of claim 30 wherein the graphics subsystem further allows the cursor to move freely when the cursor is moved away from the portion of the object and the cursor has not moved off of the snap zone.

32. The met system of claim 30 wherein the graphics subsystem further allows the user to set a size of the snap zone.

33. The system of claim 30 wherein the size of the snap zone is equal to the size of the object.

34. The system of claim 28 wherein the object includes a content and wherein a magnification of the object is determined based on the content of the object.

35. The system of claim 28 wherein at least a first object is associated with the object such that when the object is magnified, the at least the first object is magnified.

36. (canceled)

37. A system for displaying an object having a shape on a graphical user interface having a cursor, the system comprising:
a graphics subsystem for tracking a movement of the cursor and for using at least one shape parameter associated with the object and relating to displaying the object to determine the shape of the object and to magnify the object such that a magnification area conforms to the determined shape of the object in response to the cursor being placed on a magnification zone.

38. (canceled)
